(19) United States
(12) Patent Application Publication
(10) Pub. No.: US 2026/0016360 A1
(43) Pub. Date: Jan. 15, 2026

(54) SNIFFING LEAK-DETECTION DEVICE WITH A SEMICONDUCTOR GAS SENSOR AND METHOD FOR SNIFFING LEAK DETECTION

(71) Applicant: INFICON GMBH, Köln (DE)

(72) Inventor: Daniel WETZIG, Köln (DE)

(73) Assignee: INFICON GMBH, Köln (DE)

(21) Appl. No.: 18/994,873

(22) PCT Filed: Jul. 12, 2023
(86) PCT No.: PCT/EP2023/069347

§ 371 Date: Jan. 15, 2025

(30) Foreign Application Priority Data
Jul. 22, 2022 (DE) 10 2022 118 431.5

(51) Int. Cl. G01M 3/16; G01M 3/00; G01N 25/18; G01N 27/12

(52) U.S. Cl. CPC G01M 3/16; G01M 3/002; G01N 25/18; G01N 27/128

(57) ABSTRACT

A sniffing leak-detection device (10) with a measuring-gas inlet (28) for taking in measuring gas at a measuring location, wherein the measuring gas is to be investigated for the presence of a possible leakage gas at the measuring location, a reference-gas inlet (30), different from the measuring-gas inlet (28), for taking in reference gas from the surroundings of the measuring location, a gas-feeding pump (16), feeding the gas taken in through the measuring-gas inlet (28) and through the reference-gas inlet (30), a switching valve (20), which is connected to the gas-feeding pump (16) by a gas-conducting path (22) and is connected in a gas-conducting manner to the reference-gas inlet (30) and to the measuring-gas inlet (28) and formed in such a way that, dependent on the switching state of the switching valve (20), the gas-feeding pump (16) takes in gas through the measuring-gas inlet (28) and/or through the reference-gas inlet (30), and a gas sensor (18) for analyzing the gas taken in by the gas-feeding pump (16), characterized in that the gas sensor (18) has a gas-sensitive sensor area (42) with at least one physical property which changes dependent on the gas contacting the sensor area (42) and can be measured, wherein the sensor area (42) is arranged in such a way that at least some of the gas fed by the gas-feeding pump (16) is passed along the sensor and thereby contacts the sensor area (42) in order thereby to change the measurable property.

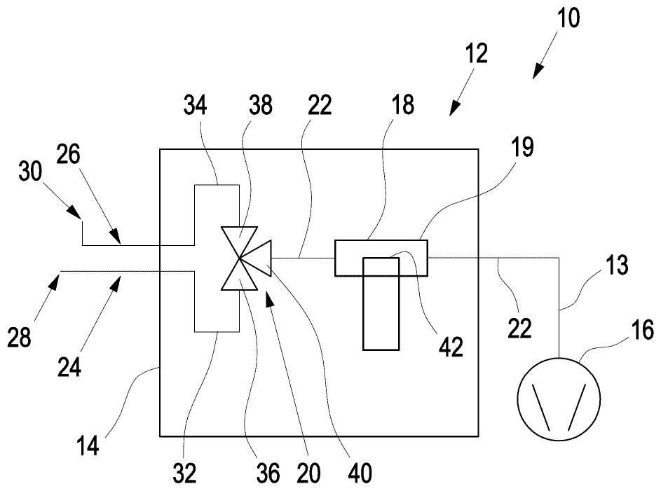

### CROSS-REFERENCE TO RELATED APPLICATIONS

This application is a national stage application filed under 35 U.S.C. § 371 of PCT Application No. PCT/EP2023/069347, filed Jul. 12, 2023, which claims priority to German patent application DE 10 2022 118 431.5, filed on Jul. 22, 2022, the entire contents of all of which are incorporated by reference herein.

### BACKGROUND OF THE DISCLOSURE

### 1. Field of the Disclosure

The disclosure relates to a sniffing leak-detection device with a measuring-gas inlet for drawing in measuring gas at a measuring location, whereby the measuring gas is to be examined for the presence of a possible leakage gas at the measuring location.

### 2. Description of Related Art

Such sniffing leak-detection devices are usually designed as hand-held probes that are connected to a gas detector for gas analysis via a gas-conducting connection line. A stream of air gas is drawn in via a sniffer tip of the sniffer probe and fed to a sensor unit in the gas detector. This involves examining whether the analyzed gas mixture contains a leakage gas that has escaped from the interior of the test specimen to the outside through a leak in the test specimen. For this purpose, the test specimen is typically filled with a known test gas, such as helium, or is already filled with a gas or refrigerant that is used as the test gas. However, there is often a natural occurrence of the test gas used in the atmosphere surrounding the test specimen. Air, for example, contains a natural proportion of helium. It is therefore important to determine the natural proportion of the test gas used in the atmosphere surrounding the test specimen that does not result from a leak in the test specimen.

For example, it is known from EP 1 342 070 B1 to use a reference-gas inlet different from the measuring-gas inlet in addition to the measuring-gas inlet of the sniffing leak-detection device. The reference-gas inlet is intended to draw in reference gas from the vicinity of the measuring location, i.e. from the vicinity of the examined test specimen and the assumed leak. This is based on the idea that the proportion of the test gas used in the reference gas does not result from a leak in the test specimen, but corresponds to the natural occurrence of the test gas used in the gas mixture examined.

A switching valve is used to switch between the reference-gas inlet and the measurement-gas inlet. A gas-feeding pump is connected to the switching valve via a gas line path, which in turn can be connected to the measuring-gas inlet and/or the reference-gas inlet as required. This means that the switching valve can be used to create a gas-conducting connection between the measurement-gas inlet and a gas sensor located in the path to the gas-feeding pump and/or a gas-conducting connection between the reference-gas inlet and the gas sensor. The gas-feeding pump then draws in gas from the measuring-gas inlet and/or the reference-gas inlet, depending on the switching state of the switching valve, and feeds the gas drawn in to the gas sensor.

In the known sniffing leak-detection devices with switching between a measuring-gas inlet and a reference-gas inlet, an optical sensor in the form of an infrared gas analyzer is typically used as the gas sensor. A measuring cuvette is filled with the gas to be analyzed and then illuminated with infrared radiation. Based on the resulting absorption spectrum, conclusions can be drawn about the composition of the gas inside the measuring cuvette.

Conventional infrared gas analyzers do not allow switching between the measuring-gas inlet and the reference-gas inlet at an optional frequency. Rather, the measuring cuvette used must first be filled with the gas mixture to be analyzed before the analysis can take place and then the gas mixture to be subsequently analyzed must be introduced into the measuring cuvette before it can be analyzed. This results in limited switching frequencies, also known as modulation frequencies, for the switching between the measuring-gas inlet and the reference-gas inlet by the switching valve. At higher frequencies, the sensitivity of the gas analysis is reduced because the gas in the measuring cuvette is not completely exchanged.

### SUMMARY OF THE DISCLOSURE

It is an object of the disclosure to provide a sniffing leak-detection device which enables rapid switching between a measuring-gas inlet and a reference-gas inlet during gas analysis.

The sniffing leak-detection device comprises a measuring-gas inlet for drawing in measuring gas at a measuring location, whereby the measuring gas is to be examined for the presence of a possible leakage gas at the measuring location. Leakage gas is a gas that has escaped through a leak in a test specimen from the interior of the test specimen into its external environment, where it is picked up by the sniffing leak-detection device. Typically, a known test gas is used as the leakage gas, with which the test specimen is filled or which is already contained in the test specimen. A reference gas inlet different from the measuring-gas inlet is provided for drawing in reference gas from the vicinity of the measuring location, i.e. from the vicinity of the area in which a leak is suspected and from which gas is drawn in through the measuring-gas inlet. A gas-feeding pump of the sniffing leak-detection device generates a gas flow through a gas line path connecting the measuring-gas inlet and the reference-gas inlet with the gas-feeding pump in order to suck in the gas through the gas inlet used in each case. A switching valve is used to connect the gas line to the measuring-gas inlet and/or the reference-gas inlet in such a way that the gas-feeding pump draws in gas through the measuring-gas inlet and/or the reference-gas inlet, depending on the switching state of the switching valve. It is possible to switch between the measuring-gas inlet and the reference-gas inlet. Alternatively, the reference-gas inlet can be briefly connected to the gas line connecting the measuring-gas inlet to the gas-feeding pump. A gas sensor analyzes the gas drawn in by the gas-feeding pump.

According to the disclosure, the gas sensor of the sniffing leak-detection device is not a conventional optical sensor, such as a conventional infrared gas analyzer, but rather a gas sensor with a sensor surface which has at least one physically measurable property which changes as a function of the gas contacting the sensor surface and which can be measured by the sensor. The sensor surface is arranged in such a way that at least part of the drawn-in gas conveyed by the gas-feeding pump through the gas line path is guided along the sensor, thereby contacting the sensor surface and changing the physical property of the sensor surface. The physical property of the sensor surface can be measured electrically, for example, with the measurement signal being evaluated to identify gas components of the gas mixture examined.

The physical property can be, for example, the electrical resistance of the sensor surface or the voltage-current characteristic. For example, the gas sensor can be a semiconductor gas sensor. Alternatively, the gas sensor can also be a thermal conductivity sensor, in which the measurable physical property of the sensor surface is the thermal conductivity, which changes depending on the contacting gas.

The disclosure offers the decisive advantage that, compared to the optical sensors known in the prior art, a significantly smaller quantity of gas is required to generate an electrical measurement signal that is suitable for gas detection. While the sensor volume of optical infrared radiation absorption sensors, for example, must be filled before a meaningful measurement signal can be generated, a gas sensor with a gas-sensitive sensor surface only requires a much smaller volume of gas which contacts or wets the sensor surface.

The disclosure thus offers the advantage that the gas volume within the gas sensor or in the measuring environment of the sensor surface can be limited to a value that enables rapid switching of the switching valve with rapid signal response of the gas sensor. Preferably, the gas volume within the gas sensor or in the measuring environment of the sensor surface is limited to a value of 1 cm³, preferably 500 mm³ and particularly preferably 100 mm³. This means that a maximum gas volume of 1 scc (standard cubic centimeter), 0.5 scc or 0.1 scc is sufficient to generate an electrically evaluable measurement signal and thus enable a high switching frequency of the switching valve. For a switching frequency of the switching valve of e.g. 4 Hz, the gas flow rate must then be 8 sccs (standard cubic centimeters per second), 4 sccs or 0.8 sccs in order to achieve a complete gas exchange for each measuring cycle.

If, on the other hand, a sniffer leak detector is operated with a larger sniffer gas flow in order to achieve a faster gas exchange in the detection volume, this leads to a greater dilution of the absorbed leakage gas quantity, which in turn is associated with a loss of sensitivity.

In principle, a faster gas exchange in the detection volume can be achieved with an unchanged sniffer gas flow by lowering the working pressure in the detection volume to a constantly lower level. This also reduces the amount of gas to be exchanged. However, this leads to a reduced test gas partial pressure, which in turn is associated with a reduced sensitivity and is therefore also not expedient.

In particular, in the sniffing leak-detection method according to the disclosure, a gas volume of less than 1 scc (standard cubic centimeter), less than 0.5 scc or particularly preferably less than 0.1 scc is guided past the sensor surface while the measurement signal is being evaluated.

The reduced amount of gas to be exchanged enables a higher gas modulation frequency with complete gas exchange in the detection volume and/or enables the sniffer gas flow to be lowered to the minimum level for complete gas exchange in the detection volume for each modulation cycle. The reduced sniffer gas flow in turn leads to an increased test gas concentration for a given leakage rate, which in turn improves the sensitivity of the detection.

Such semiconductor gas sensors are known, for example, in the form of metal-oxide sensors in which the sensor surface has a metal-oxide coating, but not in the field of sniffing leak detection.

Semiconductor sensors (e.g. SnO₂ sensors) are suitable for detecting hydrogen or hydrocarbons. However, the sensor behavior is non-linear, the signal response to changes at a low concentration level is strong, the signal change flattens out more and more with increasing concentration, at high concentrations there is only a slight signal change. A signal change at a low or medium concentration level is easily detectable, such a signal change is generated by the modulation mode, especially when the reference gas concentration is low. The disclosure utilizes this advantage of strong signal response at low concentrations as follows:
The higher the modulation frequency selected, the better the interference gas suppression during gas exchange modulation.
One restriction applies here: As soon as the signal no longer reaches the full signal swing during a fast modulation cycle, sensitivity is lost.
Optical IR radiation absorption detection requires a sufficient IR absorption distance in the measuring cuvette between the IR emitter and IR detector. The entire measuring gas cuvette must be completely filled with measuring gas or reference gas for each modulation cycle for full sensitivity. To reduce the gas volume in the cuvette, the cuvette length can be shortened, but this also shortens the IR absorption distance. An alternative solution for faster gas exchange would be a stronger gas feeding flow (gas flow), but this reduces the sample gas concentration and thus the sensitivity for leakage measurements.
Thus, it is the object to achieve rapid complete gas exchange at the sensor with the lowest possible gas flow rate in order to achieve a high modulation frequency.
A compact and sensitive sensor element is, for example, a semiconductor sensor. The use of a semiconductor sensor in connection with gas exchange modulation is not yet known.
Other sensor elements are conceivable as an alternative to the semiconductor sensor:
   Gas-selective thermal conduction sensor element
   Pirani gas detector

The switching valve is preferably designed for switching between the measuring-gas inlet and the reference-gas inlet with a switching frequency or modulation frequency of at least 4 Hz and preferably at least 8 Hz. With conventional infrared gas analyzers or other optical sensors, such a high switching frequency leads to a loss of sensitivity. However, semiconductor gas analysis enables such rapid switching with sufficiently high sensitivity to evaluate the measurement signals of both the measuring gas and the reference gas.

The switching valve can be designed to connect the reference-gas inlet to the gas line connecting the measuring-gas inlet to the gas-feeding pump with a frequency of at least 4 Hz. Here too, the frequency (modulation frequency) can be at least 8 Hz. As a result, a gas mixture is fed to the gas sensor at alternating intervals, consisting either of the measuring gas alone or of a mixture of measuring gas and reference gas.

The sensor surface of the semiconductor gas sensor preferably has an electrical resistance or current-voltage characteristic that reacts to the leakage gas or the test gas used in the test specimen. Preferably, the electrical resistance of the sensor surface or the current-voltage characteristic of the semiconductor is changed by the test gas used. A suitable test gas is helium, for example.

According to the method according to the disclosure, a gas flow is generated by the gas-feeding pump which, depending on the switching position of the switching valve, is drawn in through the measuring-gas inlet and/or the reference-gas inlet and guided along the gas line path past the gas sensor in such a way that gas components of the gas flow react with the sensor surface in such a way that the electrical resistance of the sensor surface or current-voltage characteristic of the semiconductor changes depending on the gas type of the gas component, in order to thereby detect a leakage gas or test gas drawn in through the measuring-gas inlet. The electrical resistance of the sensor surface is measured electrically, whereby the measurement signal of the resistance measurement is used for the gas analysis.

Preferably, the switching valve is switched over to the reference-gas inlet or connects the reference-gas inlet to the gas line path between the measuring-gas inlet and the gas sensor in order to examine gas drawn in through the reference-gas inlet from the surroundings of the measuring location for the presence of leakage gas components and to take these leakage gas components into account when evaluating the gas drawn in through the measuring-gas inlet. In particular, it is conceivable that the determined proportions of test gas or leakage gas in the analyzed reference gas are subtracted from the corresponding proportions of test gas or leakage gas in the analyzed measuring gas in order to determine the proportion of test gas or the test gas concentration that originates from a leak in the test specimen.

### BRIEF DESCRIPTION OF THE DRAWINGS

In the following, an exemplary embodiment of the disclosure is explained in detail with reference to the FIGURE.

The sole FIGURE shows a sniffing leak-detection device according to the disclosure.

### DETAILED DESCRIPTION OF THE DISCLOSURE

The sniffing leak-detection device 10 shown has a hand-held sniffer probe 12, which is connected to a gas-feeding pump 16 via a gas connection line 13. A gas sensor 18 is arranged in the sniffer probe 12. For this purpose, the sniffer probe 12 has a housing 14, which also encloses the gas sensor 18. A three-way switching valve 20 is also arranged in the housing 14, which is connected to the gas sensor 18 by a gas line path 22. A further section of the gas line path 22 connects the gas sensor 18 to the gas-feeding pump 16, with the portion of the gas line path 22 extending outside the housing 14 being formed by the gas connection line 13.

The housing 14 has a measuring-gas sniffer tip 24 and a reference-gas sniffer tip 26. The two sniffer tips 24, 26 can also be combined or arranged in a common housing of a common sniffer tip. Alternatively, the reference-gas sniffer tip 26 can also be attached to the housing 14 further away from the measuring-gas sniffer tip 24.

The measuring-gas sniffer tip 24 has a measuring-gas inlet 28 at its front end opposite the housing 14. In a corresponding manner, the end of the reference-gas sniffer tip 26 opposite the housing 14 is provided with a reference-gas inlet 30. It is of particular importance that the measuring-gas inlet 28 is connected to a first connection of the switching valve 20 by a measuring-gas line path 32, while the reference-gas inlet 30 is also connected to the switching valve 20 by a reference-gas line path 34, which is different from the measuring-gas line path 32. The measuring-gas line path 32 is connected to a first connection 36 of the switching valve 20, while the reference-gas line path 34 is connected to a second connection 38 of the switching valve 20, while the gas line path 22 is connected to a third connection 40 of the switching valve 20, which is different from the first two connections 36, 38.

The switching valve 20 optionally connects either the first connection 36 or the second connection 38 to the third connection 40, so that in the case of the first connection 36 the measuring-gas line path 32 is connected to the gas line path 22, while in the case of the second connection 38 the reference-gas line path 34 is connected to the gas line path 22.

Alternatively or additionally, it is possible for the switching valve 20 to connect both the first connection 36 and the second connection 38 to the third connection 40, so that in this case both the measuring-gas line path 32 and the reference-gas line path 34 are connected to the gas line path 22.

The gas sensor 18 is designed as a semiconductor sensor in the form of a metal-oxide sensor. The gas sensor 18 has a sensor surface 42 in the form of a metal-oxide surface. The sensor surface 42 is arranged within the gas sensor 18 in such a way that the gas flow guided along the gas line path 22 within the housing 14 flows past the sensor surface 42. As a result, a portion of the conveyed gas mixture comes into contact with the sensor surface 42 and influences the electrical resistance of the sensor surface 42 or the current-voltage characteristic of the transistor. The sensor resistance is changed depending on the gas type of the gas components coming into contact with the sensor surface 42.

The resistance of the sensor surface 42 is measured in an electrically conventional and known manner, whereby the gas composition at the sensor surface 42 is inferred from the measurement signal of the resistance values and thus, in particular, specific gas components, such as test gas contained in a test specimen, can be detected.

1-11. (canceled)

12. A sniffing leak-detection device, the device comprising:
a measuring-gas inlet configured to draw a measuring gas from a measuring location for examination of a possible leakage gas;
a reference-gas inlet, different from the measuring-gas inlet, configured to draw a reference gas from surroundings of the measuring location;
a gas-feeding pump configured to feed the measuring gas drawn in through the measuring-gas inlet and the reference gas drawn in through the reference-gas inlet;
a switching valve connected to the gas-feeding pump by a gas-conducting path,
wherein the switching valve is gas-conductively connected to the reference-gas inlet and to the measuring-gas inlet,
wherein the switching valve is operable to control the measuring gas drawn by the gas-feeding pump from the measuring-gas inlet, the reference gas drawn by the gas-feeding pump from the reference-gas inlet, or both depending on a switching state of the switching valve; and
a gas sensor configured to analyze the measuring gas and/or the reference gas drawn in by the gas-feeding pump,
wherein the gas sensor has a gas-sensitive sensor area with at least one measurable physical property that changes upon contact with the measuring gas and/or the reference gas, and
wherein the gas-sensitive sensor area is arranged so that at least a portion of the measuring gas and/or the reference gas that is fed by the gas-feeding pump contacts the gas-sensitive sensor area to cause a change the measurable physical property.

13. The sniffing leak-detection device according to claim 12, wherein the gas sensor is a semiconductor gas sensor with a sensor surface with an electrical resistance or current-voltage characteristic that changes depending on a type of gas.

14. The sniffing leak-detection device according to claim 13, wherein the gas sensor is a metal oxide sensor.

15. The sniffing leak-detection device according to claim 12, wherein the gas sensor is a heat conduction sensor with heat emission from a sensor surface to a gas environment being dependent on a type of gas.

16. The sniffing leak-detection device according to claim 12, wherein the gas sensor has a housing that limits a gas volume adjacent to a sensor surface of the gas sensor to 1 cubic centimeter.

17. The sniffing leak-detection device according to claim 12, wherein the gas sensor has a housing that limits a gas volume adjacent to a sensor surface of the gas sensor to 0.5 cubic centimeter.

18. The sniffing leak-detection device according to claim 12, wherein the gas sensor has a housing that limits a gas volume adjacent to a sensor surface of the gas sensor to 0.1 cubic centimeter.

19. The sniffing leak-detection device according to claim 12, wherein the switching valve is is configured to switch between the measuring-gas inlet and the reference-gas inlet at a frequency of at least 4 Hz.

20. The sniffing leak-detection device according to claim 12, wherein the switching valve is configured to connect the reference-gas inlet to the gas-conducting path, which also connects the measuring-gas inlet to the gas-feeding pump, at a frequency of at least 3 Hz.

21. The sniffing leak-detection device according to claim 19, wherein the frequency is at least 5 Hz.

22. The sniffing leak-detection device according to claim 19, wherein the frequency is at least 10 Hz.

23. The sniffing leak-detection device according to claim 20, wherein the frequency is at least 5 Hz.

24. The sniffing leak-detection device according to claim 20, wherein the frequency is at least 10 Hz.

25. The sniffing leak-detection device according to claim 12, wherein at least one measurable physical property is at least one selected from the group consisting of: electrical resistance, current-voltage characteristic, and thermal conductivity.

26. The sniffing leak-detection device according to claim 12, wherein the gas sensor and the switching valve are arranged inside a housing forming a hand-guided sniffer probe of the sniffing leak-detection device.

27. A method for sniffing leak detection with a sniffing leak-detection device, the method comprising:
using a gas-feeding pump to generate a gas flow that, based on a switching position of a switching valve, is drawn in through a measuring-gas inlet and/or a reference-gas inlet,
guiding the gas flow along a gas-conducting path past a gas sensor so that gas components react with a sensor surface, causing a change in physical property of the sensor surface depending on a gas type, thereby detecting leakage gas drawn in through the measuring-gas inlet.

28. The method of claim 27, further comprising:
switching the switching valve to connect the reference-gas inlet to the gas-conducting path to analyze gas drawn from the reference-gas inlet for leakage gas components and accounting for these components in evaluating the gas drawn through the measuring-gas inlet.

29. The method of claim 27,
wherein the sniffing leak-detection device comprises the measuring-gas inlet, the reference-gas inlet, the gas-feeding pump, the switching valve, and the gas sensor,
wherein the measuring-gas inlet is configured to draw a measuring gas from a measuring location for examination of a possible leakage gas,
wherein the reference-gas inlet is different from the measuring-gas inlet and is configured to draw a reference gas from surroundings of the measuring location,
wherein the gas-feeding pump is configured to feed the measuring gas drawn in through the measuring-gas inlet and the reference gas drawn in through the reference-gas inlet,
wherein the switching valve is connected to the gas-feeding pump by the gas-conducting path,
wherein the switching valve is gas-conductively connected to the reference-gas inlet and to the measuring-gas inlet,
wherein the switching valve is operable to control the measuring gas drawn by the gas-feeding pump from the measuring-gas inlet, the reference gas drawn by the gas-feeding pump from the reference-gas inlet, or both depending on a switching state of the switching valve; and
wherein the gas sensor is configured to analyze the measuring gas and/or the reference gas drawn in by the gas-feeding pump,
wherein the gas sensor has a gas-sensitive sensor area with at least one measurable physical property that changes upon contact with the reference gas and/or measuring gas, and
wherein gas-sensitive sensor area is arranged so that at least a portion of the measuring gas and/or the reference gas that is fed by the gas-feeding pump contacts the gas-sensitive sensor area to cause a change the measurable physical property.
